(19) United States
(12) Patent Application Publication
(10) Pub. No.: US 2020/0184863 A1
(43) Pub. Date: Jun. 11, 2020

(54) SYSTEM AND METHOD FOR TARGETED ADVERTISING BASED ON THE BACK OF CASH REGISTER PAPER

(71) Applicant: GUANGZHOU ZONERICH BUSINESS MACHINE CO., LTD., Guangzhou (CN)

(72) Inventor: Liqiang LIU, Guangzhou (CN)

(21) Appl. No.: 16/627,624

(22) PCT Filed: Jul. 17, 2017
(86) PCT No.: PCT/CN2017/093079

§ 371 Date: Dec. 30, 2019

(30) Foreign Application Priority Data
Jun. 30, 2017 (CN) 201710519193.5

(51) Int. Cl. G09F 23/10; G07G 5/00; G06Q 30/02; G06Q 20/20

(52) U.S. Cl. CPC G09F 23/10; G06Q 20/209; G06Q 30/0269; G07G 5/00

(57) ABSTRACT

The disclosure relates to a system and method for targeted advertising based on the back of cash register paper. The system includes a cloud advertisement server, at least one advertisement releasing terminal, and a plurality of double-sided printers; the plurality of double-sided printers are pre-divided into a plurality of specified classifications; the advertisement releasing terminal is used for receiving advertisement contents input by a user, generating advertisement information, and sending same to the cloud advertisement server; the cloud advertisement server is used for generating corresponding advertisement pushing information and sending same to the double-sided printers of the specified classifications; the double-sided printers are used for receiving the advertisement pushing information and printing corresponding advertisement information on a back of cash register paper.

### FIELD

The present disclosure relates to the field of information processing, and more particularly, to a system and method for targeted advertising based on the back of cash register paper.

### BACKGROUND

At present, generally speaking, a back of cash register paper is blank. If an advertisement needs to be printed on the back of the cash register paper, the advertisement is printed on the back of the cash register paper in advance according to the prior art after advertisement contents are customized by a customer, and the cash register paper is put into a checkout counter for use. This method needs to collect the advertisement contents in advance, and needs to perform a plurality of links such as transportation, printing, cash register paper distribution and the like, which consumes more manpower and material resources and has a longer time period. If targeted advertisement releasing needs to be performed, vigorous statistics needs to be performed, and advertisement information is launched through manpower planning, thus causing a high cost and a low efficiency. Moreover, in this way the advertisement contents are fixed and cannot be changed after being printed on the back of the cash register paper, which is easy to cause invalid advertisements, spam advertisements and the like, so that the advertisement information has a poor timeliness, and cannot be updated in time or released as soon as possible, and targeted advertisement releasing requirements cannot be met.

### SUMMARY

In order to solve the technical problems above, the present disclosure is intended to provide a system for targeted advertising based on the back of cash register paper, and the present disclosure is further intended to provide a method for targeted advertising based on the back of cash register paper.

The technical solution used in the present disclosure to solve the technical problems thereof is as follows.

A system for targeted advertising based on the back of cash register paper includes a cloud advertisement server, at least one advertisement releasing terminal, and a plurality of double-sided printers, wherein the cloud advertisement server is respectively and wirelessly connected with the advertisement releasing terminal and the double-sided printers, and the plurality of double-sided printers are pre-divided into a plurality of specified classifications; the advertisement releasing terminal is used for receiving advertisement contents input by a user, generating advertisement information, and sending same to the cloud advertisement server; the cloud advertisement server is used for receiving the advertisement information sent by the advertisement releasing terminal, then generating corresponding advertisement pushing information and sending same to the double-sided printers of the specified classifications; and the double-sided printers are used for receiving the advertisement pushing information and printing corresponding advertisement information on a back of cash register paper when printing cash register information.

Further, each of the specified classifications of the plurality of double-sided printers is provided with a corresponding classification code, a data format of the advertisement pushing information includes a data head, a data content and releasing time information, and the data head includes the classification codes of different specified classifications of the double-sided printers.

Further, the releasing time information is time information having a highest matching degree with the advertisement content calculated by the cloud advertisement server according to historical printing data of the plurality of double-sided printers.

Further, the specific classifications are a plurality of classifications obtained by obtaining historical printing data of the plurality of double-sided printers within a period of time, then performing data cleaning, and further clustering and grouping according to commodity information in the historical printing data.

Further, the step of data cleaning includes abnormal data processing and small probability data deletion processing.

Another technical solution used in the present disclosure to solve the technical problems thereof is as follows.

A method for targeted advertising based on the back of cash register paper includes the steps of:

receiving, by an advertisement releasing terminal, advertisement contents input by a user, generating advertisement information, and sending same to a cloud advertisement server;

receiving, by the cloud advertisement server, the advertisement information sent by the advertisement releasing terminal, generating corresponding advertisement pushing information, and sending same to double-sided printers of specified classifications; and

receiving, by the double-sided printers, the advertisement pushing information, then analyzing same, and printing corresponding advertisement information on a back of cash register paper when printing cash register information.

Further, the method further includes the following steps of:

obtaining historical printing data of a plurality of double-sided printers within a period of time, then performing data cleaning, further clustering and grouping according to commodity information in the historical printing data, and dividing the plurality of double-sided printers into a plurality of specific classifications.

Further, the method further includes the following two steps of:

sending, by the double-sided printers, the printed commodity information to the cloud advertisement server in real time; and

performing, by the cloud advertisement server, the data cleaning again according to the historical printing data of the double-sided printers periodically, further clustering and grouping according to the commodity information in the historical printing data, and updating the specific classifications of the plurality of double-sided printers.

Further, each of the specific classifications of the plurality of double-sided printers is provided with a corresponding classification code, a data format of the advertisement pushing information includes a data head, a data content and releasing time information, the data head includes the classification codes of different specific classifications of the double-sided printers, and the step of receiving, by the cloud advertisement server, the advertisement information sent by the advertisement releasing terminal, generating the corresponding advertisement pushing information, and sending the same to the double-sided printers of the specified classifications includes:

receiving, by the cloud advertisement server, the advertisement information sent by the advertisement releasing terminal, then analyzing to obtain a category of the advertisement information, and further obtaining the specific classification of the double-sided printer corresponding to the category of the advertisement information;

analyzing to obtain an advertisement content in the advertisement information as the data content, and calculating to obtain time information having a highest matching degree with the advertisement content as the releasing time information according to the historical printing data of the plurality of double-sided printers;

using the obtained classification code of the specified classification as the data head, and combining the data content and the releasing time information above to generate corresponding advertisement pushing information; and

sending the advertisement pushing information to the double-sided printers corresponding to the specific classifications.

Further, the step of receiving, by the double-sided printers, the advertisement pushing information, then analyzing the same, and printing the corresponding advertisement information on the back of the cash register paper when printing the cash register information includes:

receiving, by the double-sided printers, the advertisement pushing information, then analyzing same, and generating advertisement information of a corresponding format according to a size specification of cash register paper;

obtaining one or more pieces of corresponding advertisement information to be printed according to the releasing time information in the advertisement pushing information in combination with current time information when printing the cash register information; and

printing corresponding advertisement information on the back of the cash register paper in real time when printing the cash register information.

The present disclosure has the beneficial effect that: the system for targeted advertising based on the back of cash register paper of the present disclosure includes the cloud advertisement server, the at least one advertisement releasing terminal, and the plurality of double-sided printers, wherein the cloud advertisement server is respectively and wirelessly connected with the advertisement releasing terminal and the double-sided printers, and the plurality of double-sided printers are pre-divided into the plurality of specified classifications; the advertisement releasing terminal is used for receiving the advertisement contents input by the user, generating the advertisement information, and sending the same to the cloud advertisement server; the cloud advertisement server is used for receiving the advertisement information sent by the advertisement releasing terminal, generating the corresponding advertisement pushing information, and sending the same to the double-sided printers of the specified classifications; and the double-sided printers are used for receiving the advertisement pushing information and printing the corresponding advertisement information on the back of the cash register paper when printing the cash register information. The system can timely send the advertisement information to be sent to the double-sided printers for targeted printing, can print various pieces of advertisement information without consuming a large amount of manpower and material resources for printing in advance, is relatively environment-friendly, can update or release the advertisement information at any time, and can release targeted classified advertisements, a timeliness is high, and requirements of advertisement information pushing can be met.

The present disclosure has another beneficial effect that: the method for targeted advertising based on the back of cash register paper includes the steps of receiving, by the advertisement releasing terminal, the advertisement contents input by the user, generating the advertisement information, and sending the same to the cloud advertisement server; receiving, by the cloud advertisement server, the advertisement information sent by the advertisement releasing terminal, generating the corresponding advertisement pushing information, and sending the same to the double-sided printers of the specified classifications; and receiving, by the double-sided printers, the advertisement pushing information, then analyzing the same, and printing the corresponding advertisement information on the back of the cash register paper when printing the cash register information. The method can timely send the advertisement information to be sent to the double-sided printers for targeted printing, can print various pieces of advertisement information without consuming a large amount of manpower and material resources for printing in advance, is relatively environment-friendly, can update or release the advertisement information at any time, and can release targeted classified advertisements, a timeliness is high, and requirements of advertisement information pushing can be met.

### BRIEF DESCRIPTION OF THE DRAWINGS

The present disclosure is further described hereinafter with reference to the drawings and the embodiments.

FIG. 1 shows a structural block diagram of a system for targeted advertising based on the back of cash register paper according to the present disclosure; and

FIG. 2 shows a flowchart of a specific embodiment of a method for targeted advertising based on the back of cash register paper according to the present disclosure.

### DETAILED DESCRIPTION

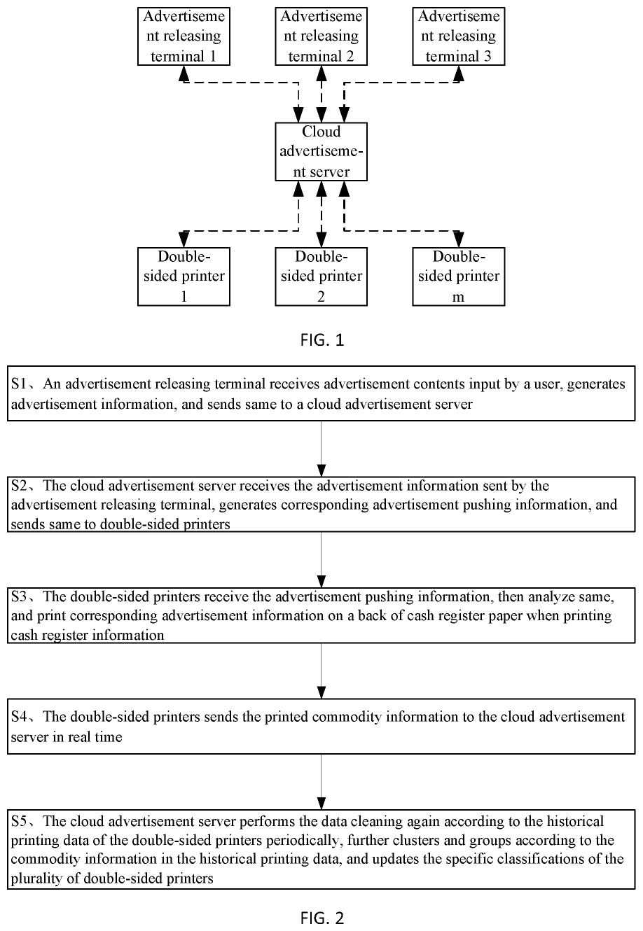

With reference to FIG. 1, the present disclosure provides a system for targeted advertising based on the back of cash register paper, which includes a cloud advertisement server, at least one advertisement releasing terminal, and a plurality of double-sided printers, wherein the cloud advertisement server is respectively and wirelessly connected with the advertisement releasing terminal and the double-sided printers, and the plurality of double-sided printers are pre-divided into a plurality of specified classifications; the advertisement releasing terminal is used for receiving advertisement contents input by a user, generating advertisement information, and sending same to the cloud advertisement server; the cloud advertisement server is used for receiving the advertisement information sent by the advertisement releasing terminal, then generating corresponding advertisement pushing information and sending same to the double-sided printers of the specified classifications; and the double-sided printers are used for receiving the advertisement pushing information and printing corresponding advertisement information on a back of cash register paper when printing cash register information.

In a further preferred embodiment, each of the specified classifications of the plurality of double-sided printers is provided with a corresponding classification code, a data format of the advertisement pushing information includes a data head, a data content and releasing time information, and the data head includes the classification codes of different specified classifications of the double-sided printers.

In a further preferred embodiment, the releasing time information is time information having a highest matching degree with the advertisement content calculated by the cloud advertisement server according to historical printing data of the plurality of double-sided printers.

In a further preferred embodiment, the specific classifications are a plurality of classifications obtained by obtaining historical printing data of the plurality of double-sided printers within a period of time, then performing data cleaning, and further clustering and grouping according to commodity information in the historical printing data.

In a further preferred embodiment, the step of data cleaning includes abnormal data processing and small probability data deletion processing.

The present disclosure also provides a method for targeted advertising based on the back of cash register paper, which includes the steps of:

receiving, by an advertisement releasing terminal, advertisement contents input by a user, generating advertisement information, and sending same to a cloud advertisement server;

receiving, by the cloud advertisement server, the advertisement information sent by the advertisement releasing terminal, generating corresponding advertisement pushing information, and sending same to double-sided printers of specified classifications; and

receiving, by the double-sided printers, the advertisement pushing information, then analyzing same, and printing corresponding advertisement information on a back of cash register paper when printing cash register information.

In a further preferred embodiment, the method further includes the following steps of:

obtaining historical printing data of a plurality of double-sided printers within a period of time, then performing data cleaning, further clustering and grouping according to commodity information in the historical printing data, and dividing the plurality of double-sided printers into a plurality of specific classifications.

In a further preferred embodiment, the method further includes the following two steps of:

sending, by the double-sided printers, the printed commodity information to the cloud advertisement server in real time; and

performing, by the cloud advertisement server, the data cleaning again according to the historical printing data of the double-sided printers periodically, further clustering and grouping according to the commodity information in the historical printing data, and updating the specific classifications of the plurality of double-sided printers.

In a further preferred embodiment, each of the specific classifications of the plurality of double-sided printers is provided with a corresponding classification code, a data format of the advertisement pushing information includes a data head, a data content and releasing time information, the data head includes the classification codes of different specific classifications of the double-sided printers, and the step of receiving, by the cloud advertisement server, the advertisement information sent by the advertisement releasing terminal, generating the corresponding advertisement pushing information, and sending the same to the double-sided printers of the specified classifications includes:

receiving, by the cloud advertisement server, the advertisement information sent by the advertisement releasing terminal, then analyzing to obtain a category of the advertisement information, and further obtaining the specific classification of the double-sided printer corresponding to the category of the advertisement information;

analyzing to obtain an advertisement content in the advertisement information as the data content, and calculating to obtain time information having a highest matching degree with the advertisement content as the releasing time information according to the historical printing data of the plurality of double-sided printers;

using the obtained classification code of the specified classification as the data head, and combining the data content and the releasing time information above to generate corresponding advertisement pushing information; and

sending the advertisement pushing information to the double-sided printers corresponding to the specific classifications.

In a further preferred embodiment, the step of receiving, by the double-sided printers, the advertisement pushing information, then analyzing the same, and printing the corresponding advertisement information on the back of the cash register paper when printing the cash register information includes:

receiving, by the double-sided printers, the advertisement pushing information, then analyzing same, and generating advertisement information of a corresponding format according to a size specification of cash register paper;

obtaining one or more pieces of corresponding advertisement information to be printed according to the releasing time information in the advertisement pushing information in combination with current time information when printing the cash register information; and

printing corresponding advertisement information on the back of the cash register paper in real time when printing the cash register information.

The present disclosure is described in detail hereinafter with reference to more specific embodiments.

With reference to FIG. 1, a system for targeted advertising based on the back of cash register paper includes a cloud advertisement server, at least one advertisement releasing terminal, and a plurality of double-sided printers, wherein the cloud advertisement server is respectively and wirelessly connected with the advertisement releasing terminal and the double-sided printers, and the plurality of double-sided printers are pre-divided into a plurality of specified classifications; the advertisement releasing terminal is used for receiving advertisement contents input by a user, generating advertisement information, and sending same to the cloud advertisement server; the cloud advertisement server is used for receiving the advertisement information sent by the advertisement releasing terminal, then generating corresponding advertisement pushing information and sending same to the double-sided printers of the specified classifications; and the double-sided printers are used for receiving the advertisement pushing information and printing corresponding advertisement information on a back of cash register paper when printing cash register information. FIG. 1 shows an advertisement releasing terminal 1 to an advertisement releasing terminal n as well as a double-sided printer 1 to a double-sided printer m, wherein n is a positive integer greater than or equal to 1, and m is a positive integer greater than or equal to 2.

In the embodiment, each of the specified classifications of the plurality of double-sided printers is provided with a corresponding classification code, a data format of the advertisement pushing information includes a data head, a data content and releasing time information, and the data head includes the classification codes of different specified classifications of the double-sided printers. The releasing time information is time information having a highest matching degree with the advertisement content calculated by the cloud advertisement server according to historical printing data of the plurality of double-sided printers. The releasing time information specifically refers to an advertisement releasing time or period, which, for example, may be set as day and night, working day and weekend, or a specific period of time. Therefore, the advertisement pushing information generated has a group of the double-sided printer of the specified classification and time information expected to be released in the advertisement pushing information. For example, a type of advertisement information released by certain advertisement releasing terminal corresponds to a group of a double-sided printer of an A specific classification, and corresponding releasing time information is Monday to Friday, then the advertisement pushing information generated by the cloud advertisement server may carry the two pieces of information, so that the double-sided printer may finally perform targeted advertisement releasing.

The specific classification of the double-sided printer associated with the advertisement pushing information may be specified by the advertisement releasing terminal when generating the advertisement information, or may be the specific classification most matching with the advertisement information obtained by the cloud advertisement server after matching according to a content of the advertisement information, thus ensuring targeted releasing of the advertisement information. The advertisement information includes various advertisement contents and may also be various pieces of coupon information.

The specific classifications can be divided according to a distribution area, industry information or printed commodity information of the plurality of double-sided printers. For example, the specific classifications are simply divided according to different cells, different streets, merchants of different brands, merchants of different industries or merchants selling different types of products.

Preferably, in the embodiment, the specific classifications are a plurality of classifications obtained by obtaining historical printing data of the plurality of double-sided printers within a period of time, then performing data cleaning, and further clustering and grouping according to commodity information in the historical printing data.

The step of data cleaning includes abnormal data processing and small probability data deletion processing. The abnormal data processing refers to removal of data not belonging to commodity information obviously, and the small probability data deletion processing refers to deletion of data of commodities with occurrence times less than a preset proportion threshold in the historical printing data, so that the commodities that rarely appear obviously can be removed during classification according to the commodity information, thus avoiding generation of invalid classification.

The advertisement releasing terminal may be a specially configured computer, or a mobile phone with a corresponding authority, or an APP with an advertisement information releasing function. In the present disclosure, the advertisement releasing terminal mainly plays a role of an information releasing interface. When a user releases the advertisement information, the information can be sent to the advertisement releasing terminal through various intelligent terminals, edited by an operator of the advertisement releasing terminal, and sent to the cloud advertisement server.

As long as the double-sided printer is configured in advance at each charging terminal, such as convenience store, shop, supermarket and the like, and wireless communication is established between the double-sided printer and the cloud advertisement server, the system can timely acquire the historical printing data of the double-sided printer within a period of time. After analyzing the historical printing data, the cloud advertisement server can divide the double-sided printers into the plurality of specific classifications, thus matching when receiving the advertisement information of the advertisement releasing terminal. Most appropriate specific classification of the double-sided printer is specified, and most appropriate releasing time information is set after matching the advertisement information, thus timely sending the advertisement information to be sent to the double-sided printer for printing. Various pieces of advertisement information can be printed without consuming a large amount of manpower and material resources for printing in advance, the advertisement information can be updated or released at any time, a timeliness is high, targeted classified advertisements can also be released, and requirements of advertisement information pushing can be met. Moreover, the method is relatively environment-friendly without consuming additional materials.

Correspondingly, an advertisement releasing method based on the embodiment is as follows.

With reference to FIG. 2, the method for targeted advertising based on the back of cash register paper includes the steps as follows.

In S0, historical printing data of a plurality of double-sided printers within a period of time is obtained, then data cleaning is performed, clustering and grouping are further performed according to commodity information in the historical printing data, and the plurality of double-sided printers are divided into a plurality of specific classifications, wherein the performing data cleaning includes performing abnormal data processing and small probability data deletion processing. The abnormal data processing refers to removal of data not belonging to commodity information obviously, and the small probability data deletion processing refers to deletion of data of commodities with occurrence times less than a preset proportion threshold in the historical printing data, so that the commodities that rarely appear obviously can be removed during classification according to the commodity information, thus avoiding generation of invalid classification. The clustering and grouping according to the commodity information in the historical printing data refers to grouping the plurality of double-sided printers according to the category of the commodity information printed by the double-sided printer. For example, if the commodity information in the historical printing data of certain double-sided printer is mainly a stationery type, the information is clustered into a group named “stationery”, and if the commodity information in the historical printing data of certain double-sided printer is mainly a clothing type, the information can be clustered into a group named “clothing”, and so on. Similar groups such as “catering” and “convenience store” can also be obtained, and finally, each group acts as a specific classification.

In S1, an advertisement releasing terminal receives advertisement contents input by a user, generates advertisement information, and sends same to a cloud advertisement server.

In S2, the cloud advertisement server receives the advertisement information sent by the advertisement releasing terminal, generates corresponding advertisement pushing information, and sends same to double-sided printers of specified classifications.

In S3, the double-sided printers receive the advertisement pushing information, then analyze same, and print corresponding advertisement information on a back of cash register paper when printing cash register information.

In S4, the double-sided printers send the printed commodity information to the cloud advertisement server in real time.

In S5, the cloud advertisement server performs the data cleaning again according to the historical printing data of the double-sided printers periodically, further clusters and groups according to the commodity information in the historical printing data, and updates the specific classifications of the plurality of double-sided printers.

In the embodiment, each of the specified classifications of the plurality of double-sided printers is provided with a corresponding classification code, a data format of the advertisement pushing information includes a data head, a data content and releasing time information, and the data head includes the classification codes of different specified classifications of the double-sided printers. The step S2 includes:

S21: receiving, by the cloud advertisement server, the advertisement information sent by the advertisement releasing terminal, then analyzing to obtain a category of the advertisement information, and further obtaining the specific classification of the double-sided printer corresponding to the category of the advertisement information;

S22: analyzing to obtain an advertisement content in the advertisement information as the data content, and calculating to obtain time information having a highest matching degree with the advertisement content as the releasing time information according to the historical printing data of the plurality of double-sided printers;

S23: using the obtained classification code of the specified classification as the data head, and combining the data content and the releasing time information above to generate corresponding advertisement pushing information; and

S24: sending the advertisement pushing information to the double-sided printers corresponding to the specific classifications.

The step S21 more specifically includes:

receiving, by the cloud advertisement server, the advertisement information sent by the advertisement releasing terminal, and using specific classification most matching with the advertisement information obtained after matching according to the content of the advertisement information as specific classification of a double-sided printer corresponding to advertisement information of the category; and specifying classification of the corresponding double-sided printer after matching through the cloud advertisement server, which can ensure targeted releasing of the advertisement information.

Specifically, the step S3 includes:

S31: receiving, by the double-sided printers, the advertisement pushing information, then analyzing same, and generating advertisement information of a corresponding format according to a size specification of cash register paper;

S32: obtaining one or more pieces of corresponding advertisement information to be printed according to the releasing time information in the advertisement pushing information in combination with current time information when printing the cash register information; and

S33: printing corresponding advertisement information on the back of the cash register paper in real time when printing the cash register information.

The step S32 specifically includes:

S321: obtaining the cash register information to be printed and calculating a size of the occupied cash register paper when printing the cash register information;

S322: calculating a printing number of the printable advertisement information according to the calculated size of the cash register paper occupied by the cash register information; and

S323: obtaining one or more pieces of corresponding advertisement information to be printed according to the releasing time information in the advertisement pushing information in combination with the calculated printing number and the current time information, and preferentially obtaining advertisement information with a high priority level according to a preset priority level when obtaining the multiple pieces of advertisement information to be printed. For example, if releasing time information of multiple pieces of advertisement pushing information meets requirements, the multiple pieces of advertisement information shall be obtained, and advertisement information with a high priority level is preferentially printed according to a priority level. If a space of the cash register paper is sufficient, all the advertisement information is printed. Otherwise, a part of the advertisement information with a high priority level is printed before finishing.

Therefore, according to the present disclosure, by adopting the cloud advertisement server, the advertisement releasing terminal and the plurality of double-sided printers, the advertisement information to be sent can be timely sent to the double-sided printers for targeted printing through a communication network, various pieces of advertisement information can be printed without consuming a large amount of manpower and material resources for printing in advance, the advertisement information can be updated or released at any time, and targeted advertisement releasing can be performed according to classifications of the double-sided printers. The method has a high timeliness and can meet requirements of advertisement information pushing.

The forgoing describes the preferred embodiments of the present disclosure in detail, but the present disclosure is not limited to the embodiments. Those skilled in the art can also make various equivalent modifications or substitutions without departing from the spirit of the present disclosure, and these equivalent modifications or substitutions shall all fall within the scope defined in the claims of the present application.

1. A system for targeted advertising based on the back of cash register paper, comprising
a cloud advertisement server,
at least one advertisement releasing terminal, and
a plurality of double-sided printers,
wherein the cloud advertisement server is respectively and wirelessly connected with the advertisement releasing terminal and the double-sided printers, and the plurality of double-sided printers are pre-divided into a plurality of specified classifications;
the advertisement releasing terminal is used for receiving advertisement contents input by a user, generating advertisement information, and sending same to the cloud advertisement server;
the cloud advertisement server is used for receiving the advertisement information sent by the advertisement releasing terminal, generating corresponding advertisement pushing information, and sending same to the double-sided printers of the specified classifications; and
the double-sided printers are used for receiving the advertisement pushing information and printing corresponding advertisement information on a back of cash register paper when printing cash register information.

2. The system according to claim 1, wherein each of the specified classifications of the plurality of double-sided printers is provided with a corresponding classification code, a data format of the advertisement pushing information comprises a data head, a data content and releasing time information, and the data head comprises the classification codes of different specified classifications of the double-sided printers.

3. The system according to claim 2, wherein the releasing time information is time information having a highest matching degree with the advertisement content calculated by the cloud advertisement server according to historical printing data of the plurality of double-sided printers.

4. The system according to claim 1, wherein the specific classifications are a plurality of classifications obtained by obtaining historical printing data of the plurality of double-sided printers within a period of time, then performing data cleaning, and further clustering and grouping according to commodity information in the historical printing data.

5. The system according to claim 4, wherein the data cleaning comprises abnormal data processing and small probability data deletion processing.

6. A method for targeted advertising based on the back of cash register paper, comprising the steps of:
receiving, by an advertisement releasing terminal, advertisement contents input by a user, generating advertisement information, and sending same to a cloud advertisement server;
receiving, by the cloud advertisement server, the advertisement information sent by the advertisement releasing terminal, generating corresponding advertisement pushing information, and sending same to double-sided printers of specified classifications; and
receiving, by the double-sided printers, the advertisement pushing information, then analyzing same, and printing corresponding advertisement information on a back of cash register paper when printing cash register information.

7. The method according to claim 6, further comprising the following steps of:
obtaining historical printing data of a plurality of double-sided printers within a period of time, then performing data cleaning, further clustering and grouping according to commodity information in the historical printing data, and dividing the plurality of double-sided printers into a plurality of specific classifications.

8. The method according to claim 7, further comprising the following two steps of:
sending, by the double-sided printers, the printed commodity information to the cloud advertisement server in real time; and
performing, by the cloud advertisement server, the data cleaning again according to the historical printing data of the double-sided printers periodically, further clustering and grouping according to the commodity information in the historical printing data, and updating the specific classifications of the plurality of double-sided printers.

9. The method according to claim 7, wherein each of the specific classifications of the plurality of double-sided printers is provided with a corresponding classification code, a data format of the advertisement pushing information comprises a data head, a data content and releasing time information, the data head comprises the classification codes of different specific classifications of the double-sided printers, and the step of receiving, by the cloud advertisement server, the advertisement information sent by the advertisement releasing terminal, generating the corresponding advertisement pushing information, and sending the same to the double-sided printers of the specified classifications comprises:
receiving, by the cloud advertisement server, the advertisement information sent by the advertisement releasing terminal, then analyzing to obtain a category of the advertisement information, and further obtaining the specific classification of the double-sided printer corresponding to the category of the advertisement information;
analyzing to obtain an advertisement content in the advertisement information as the data content, and calculating to obtain time information having a highest matching degree with the advertisement content as the releasing time information according to the historical printing data of the plurality of double-sided printers;
using the obtained classification code of the specified classification as the data head, and combining the data content and the releasing time information above to generate corresponding advertisement pushing information; and
sending the advertisement pushing information to the double-sided printers corresponding to the specific classifications.

10. The method according to claim 8, wherein the step of receiving, by the double-sided printers, the advertisement pushing information, then analyzing the same, and printing the corresponding advertisement information on the back of the cash register paper when printing the cash register information comprises:
receiving, by the double-sided printers, the advertisement pushing information, then analyzing same, and generating advertisement information of a corresponding format according to a size specification of cash register paper;
obtaining one or more pieces of corresponding advertisement information to be printed according to the releasing time information in the advertisement pushing information in combination with current time information when printing the cash register information; and
printing corresponding advertisement information on the back of the cash register paper in real time when printing the cash register information.
